(19) United States
(12) Patent Application Publication
(10) Pub. No.: US 2003/0038005 A1
(43) Pub. Date: Feb. 27, 2003

(54) Viscous damper for machinery mounting

(76) Inventors: Jerry D. Folkens, Neperville, IL (US); Harold E. Reinke, Naperville, IL (US); Steven M. Veroeven, Willow Springs, IL (US); Joseph L. Bastl, Willowbrook, IL (US)

Correspondence Address: R. Jonathan Peters, Suite 411, 77 West Washington Street, Chicago, IL, 60602, US

(21) Appl. No.: 09/935,262

(22) Filed: Aug. 22, 2001

(51) Int. Cl. F16F 7/10

(52) U.S. Cl. 188/380; 188/378

(57) ABSTRACT

Viscous damper for a machinery mounting having a dampening member disposed intermediate a top support engagable with at least a portion of a load and a bottom plate disposed beneath the support and spaced therefrom to thereby decrease or deaden vibrations. The damper includes a receptacle for vertical disposition, which is closed at the bottom and opened at the top, and is adaptable for containing a viscous fluid. A plunger of smaller lateral dimensions is arranged concentrically and co-axially within the receptacle, and depends downwardly from the horizontally disposed support, and is of such a longitudinal dimension as to be spaced from the closed bottom of the receptacle so as to be submerged partially in the viscous fluid and is therefore free to move vertically. A perforated plate is affixed at the bottom of the plunger, and provides fluid communication between the receptacle and the plunger. The damping effected by the vibrations will force the viscous medium through the apertures in the bottom plate in one direction or the other.

### FIELD OF THE INVENTION

This invention relates to a vibration damper. More specifically, this invention relates to a viscous damper, incorporated in a machinery mounting or isolator system, to substantially decrease or deaden vibrations caused by forces external or internal to the machine.

### BACKGROUND AND PRIOR ART

Extremely heavy loads such as machinery, equipment, presses, and the like, are subjected to shock and vibration and are susceptible to misalignment due to these forces and/or due to settling including settling of the building floor or building foundation. (As used herein and in the appended claims, the term “machinery” is used generically herein and in the appended claims, and is intended to include all such machinery, equipment, apparatus, etc.) Proper alignment, including leveling, flatness, and the like, is essential in order to operate efficiently, economically and safely, and therefore it is important to diminish or substantially eliminate shock and vibrations.

The prior art discloses various types or designs of adjustable mounts or isolating mounts to correct for out-of-level or out-of-flatness conditions. In addition, it is desirable to protect or isolate the machinery from the surrounding environment as much as possible from the damaging effects of shock and vibration. Heavy machinery, for example punch presses standing twenty feet or higher and weighing as much as a million pounds or more, can be damaged or become misaligned, and therefore it is necessary to absorb or dampen as much of the shock and vibration as possible. Isolators are utilized for this purpose which, as known or shown in the art, incorporate, in general, a damping means interposed between the load and a bearing member positioned on the substructure, and include friction isolating dampers, hydraulic isolating dampers, and viscous isolating dampers. In the prior art, the isolating machinery mount typically incorporates an elastomeric cushion member, which is positioned below a bearing member and rests on the substructure or building floor. In this manner, the machine is protected from undesirable shock and vibrations.

This prior art includes, for example, U.S. Pat. Nos. 3,332,647; 4,047,427; 4,648,577; and 4,846,436. In U.S. Pat. No. 4,648,577, a damper plunger of a frusto-conical configuration includes a top plate for supporting the load (e.g., machine) and is positioned for movement in and out of a housing containing a viscous damping medium. The frustum plunger has holes in the wall for throttling the viscous medium upon movement of the viscous medium, and preferably includes a bank of tubes to provide an additional damping force.

### SUMMARY OF THE INVENTION

In accordance with the present invention, there is provided an improved vibration isolating mounting system for machinery, or the like, for at least a portion of a load positioned or arranged on a substructure such as a building floor. The vibration isolating mount includes a horizontally disposed top member or platform engagable with at least a portion of the load (e.g., foot of a machine), and a bottom member disposed beneath the top member and spaced therefrom. The vibration isolating mounting system includes a dampening member disposed between the top member or platform and the bottom member to decrease or deaden vibrations caused by external and internal forces. The damping member comprises a viscous vibration damper to minimize or substantially eliminate shock and vibrations, and is incorporated in and useful for a machinery mount for supporting at least a portion of a load to be positioned on a substructure such as the floor of a building.

The dampening member includes a receptacle, vessel, or the like, having a closed bottom and open top, and, as viewed in cross-section relative to the longitudinal axis of the receptacle, opposed parallel walls. The receptacle or vessel is adaptable for containing a viscous fluid or dampening fluid. In a preferred embodiment of the invention, the receptacle or vessel is seated directly onto the bottom member, and both typically being metallic, e. g. steel, the receptacle or vessel can be welded at the marginal edge or perimeter to the bottom member. In this manner, this receptacle or vessel is closed at the bottom, thereby obviating the need for a separate metal bottom as a closure. A plunger, having opposed parallel walls as viewed in vertical cross-section, is of smaller horizontal dimensions than the receptacle or vessel and is arranged concentrically and co-axially therewith so as to be spaced from the walls of the receptacle or vessel. The plunger depends downwardly from the horizontally disposed top member or platform, and is of such a longitudinal dimension as to be spaced from the closed bottom of the receptacle or vessel so as to be submerged partially in the viscous fluid. Thus, the plunger being spaced from the bottom of the receptacle or vessel is therefore free to move or reciprocate vertically, as well as horizontally, rotationally, and on a tilt relative to the horizontal and in the viscous medium with reference to the receptacle. A transverse bottom plate member is affixed at or near the bottom of the plunger, and the bottom plate member is provided with a plurality of apertures or openings to provide fluid communication between the receptacle or vessel and the plunger. Where desired, the bottom plate is comprised of two or more plates with aligned apertures to enhance the damping forces. The vertical motion of the plunger will force the viscous medium through the apertures in one direction or the other.

It will be observed that the receptacle or vessel is affixed to the bottom member so as to enclose the bottom of this vessel, and the plunger is affixed to the top member or platform to enclose the top of the plunger. Where desired, the receptacle or vessel and the plunger may be provided with an enclosed end, which is then affixed to the bottom member and top member, respectively, but it is preferable to affix each at its marginal edge or perimeter to the bottom member and to the top member. In order to provide sufficient strength to the unit, there is provided at least one strengthening member of still smaller dimensions than the plunger so as to be disposed interiorily of the plunger, and extends downwardly from the top platform and terminates at the perforated plate, so as to enhance the strength of the damping unit.

It should be understood that the receptacle or vessel, and plunger, may have any desired cross-section as viewed in plan, including circular, rectangular, and elliptical, and that the configuration, as viewed in horizontal cross-section, of each such member is the same. It will be observed that the side walls of each such member are therefore parallel, as viewed in vertical cross-section. Further, the walls of each such meamber are spaced equally from an adjacent member in order to provide the proper fluid movement in that region to achieve maximum dampening.

### BRIEF DESCRIPTION OF THE ACCOMPANYING DRAWINGS

The invention and its advantages will be more readily understood by reference to the following detailed description and exemplary embodiments when read in conjunction with the following drawings, wherein:

FIG. 1 is a perspective view of a viscous damper embodying the features of the present invention and useful in conjunction with a machinery mounting system supporting a load.

FIG. 2 is perspective view showing a viscous damper as in FIG. 1 illustrating a modified embodiment utilizing springs for the machinery mounting system.

FIG. 3 is perspective view of a machinery mounting system similar to that of FIG. 2 showing a viscous damper as in FIG. 1 and illustrating a modified embodiment for utilizing springs for the mounting system.

FIG. 4 is a plan view of the vibration isolation mount of the type shown in FIG. 2 showing some of the detail of the damper features of the present invention, and embodying the features of the present invention.

FIG. 5 is an elevational view, in cross-section, taken on line 5-5 of FIG. 4, and illustrating the vibration damper in greater detail.

FIG. 6 is a plan view of the bottom plate, which is perforated, used in the vibration damper of the invention.

FIG. 7 is an elevational view, in cross-section, taken on line 7-7 of FIG. 6, and illustrating the bottom plate.

FIG. 8 is an elevational view partially broken away, in cross-section, of the damper of FIG. 2 illustrating the use of a bellows.

FIG. 9 is an elevational view, in cross-section, of the damper illustrating a modified embodiment of the invention.

FIG. 10 is a view similar to FIGS. 1, 2 and 3 illustrating a modified embodiment of the invention. FIG. 11 is a plan view of the vibration isolation mount of the type shown in FIG. 10 showing in some detail the damper features of the present invention.

FIG. 12 is a plan view of the bottom plate, which is perforated, used in the alternative embodiment of the vibration damper of the invention shown in FIG. 10 and FIG. 11.

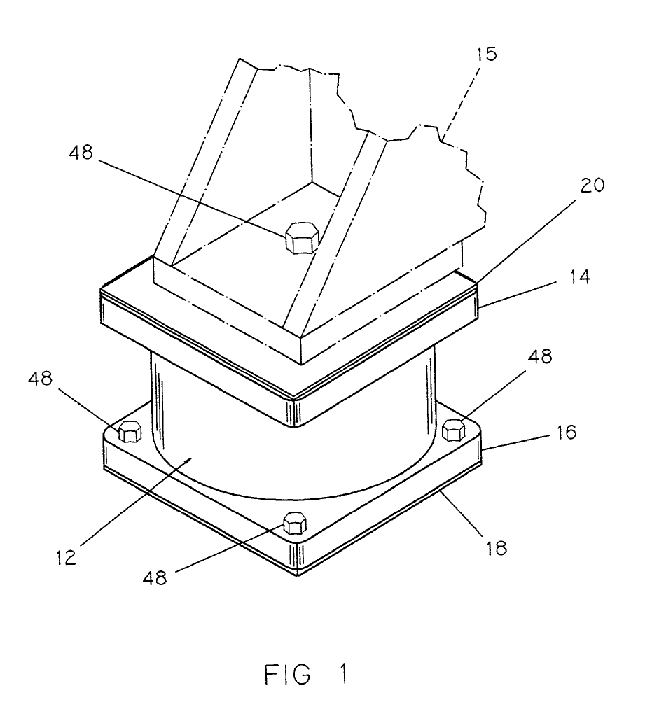

### DETAILED DESCRIPTION OF THE INVENTION

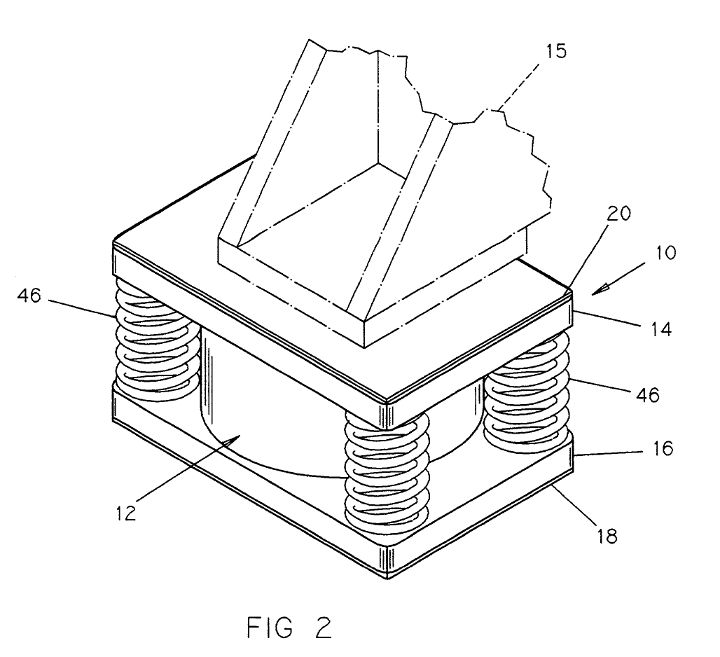

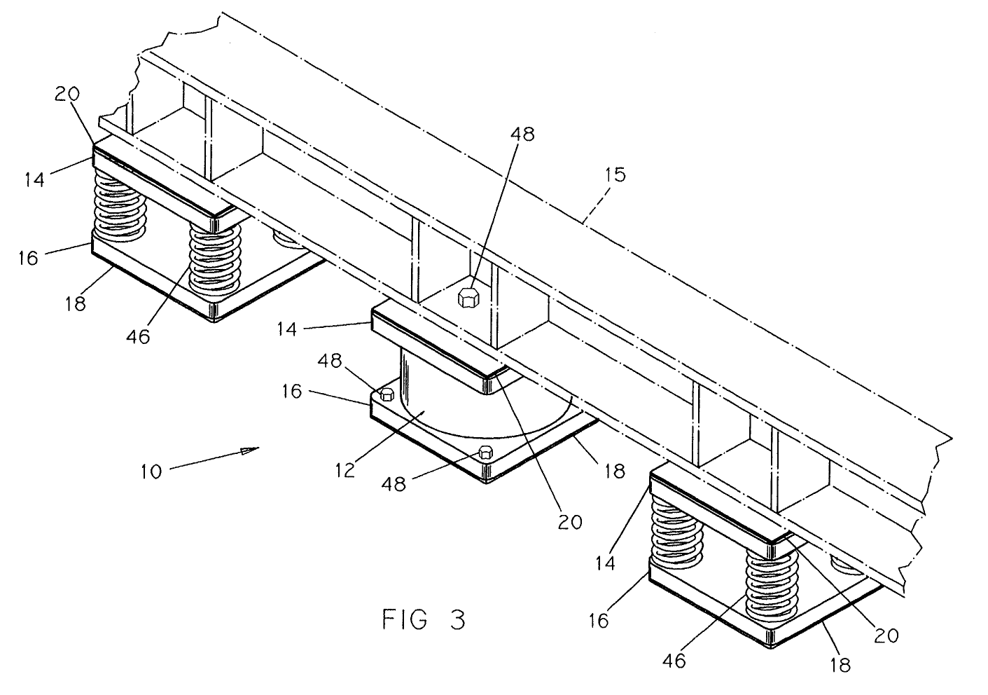

In referring to the drawings, wherein like reference numerals designate similar parts throughout the several views, there is illustrated in FIGS. 2 and 3 a machine mounting system or isolator, generally indicated by the numeral 10, to absorb vibrations and shock. The machinery mount illustrated more specifically in FIGS. 2 and 3 is a vibration isolation mounting system incorporating the features of a viscous damper. The machine mounting system 10 includes a damper, indicated generally by the numeral 12 and described below in detail, and includes a horizontally disposed top or top member or platform 14 for supporting a load 15 and spaced above a bottom or bearing member 16 seated on a substructure (not shown). The load member 15, shown in phantom, may be a foot of a heavy machine seated on the top member or platform 14, which typically has a substantially planar top surface. The bottom or bearing member 16 is positioned on a substructure such as the floor of a building (not shown). The isolator system typically includes an elastomeric cushion 18, which is compressible and resilient, disposed in immediate supporting relationship below the bottom or bearing member 16, and includes a similarly elastomeric cushion 20 disposed in immediate supporting relationship below the load. Although there is illustrated a single mounting unit (see FIGS. 2 and 3), it should be understood that the same unit can be used at each of the various mounting points of a machine, e.g. along one side of a machine or at each of the four corner feet of a machine, for absorbing shock and vibrations. It is understood in this art that a machine may have multiple mounting points.

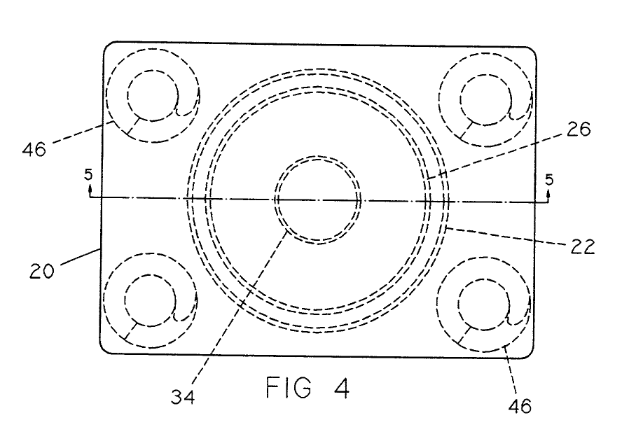

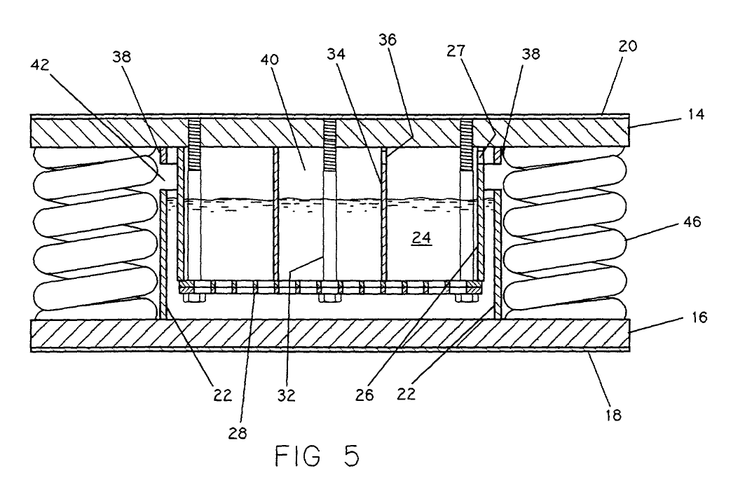

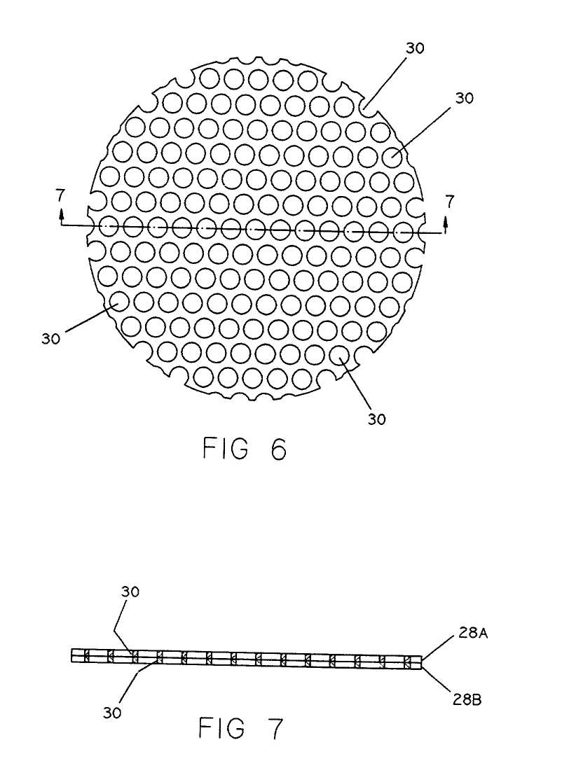

Referring now to FIGS. 4-7 in particular, the mounting system or isolator 10 having a damper 12 includes a substantially cylindrical metal member 22 as a receptacle, container, vessel, or the like, disposed in a vertical position, that is, the longitudinal axis of the vessel is essentially vertical and substantially normal to the bearing member 16. It should be understood that the terms receptacle, container, vessel, vat, tank, tub, and the like, are used herein and in the appended claims as synonymous terms and used interchangeably as referring to the receptacle for holding the viscous fluid 24. Although the receptacle for this embodiment is described as cylindrical, it should be understood that other configurations can be used, as explained below. The receptacle 22 is seated on the bottom or bearing member 16, such as a metal plate, which is spaced from a base member or substructure not shown (e.g., floor) by a resilient member 18, such as an elastomeric cushion disposed on the substructure. The receptacle 22 is affixed at the bottom marginal edge to the metal bearing plate 16, as by welding or the like, so as to be fluid-tight. Further, the receptacle 22 is open at the top, and a dampening fluid 24 (see FIG. 5) is added to the receptacle, for the reasons explained below in detail.

It further will be observed that the bottom or bearing member 16 is spaced from the substructure or building floor by the elastomeric cushion 18, and the top or support member 14 is spaced from the load 15 by elastomeric cushion 20. Thus, any vibrations transmitted through the floor (or foundation) below the cushion member 18 will be dampened at least partially and not fully transmitted to any equipment resting on the machinery supporting member 16. Similarly, any vibration or impact forces generated by the operation of a machine resting on member 16 will be only partially transmitted to the floor through the mount 10 and damping member 12.

A plunger 26 of substantially uniform cross-section depends downwardly from the bottom surface or underside of the top member or platform 14, and is affixed thereto at its top marginal edge as by welding. The plunger is of smaller diameter than the receptacle, and is disposed interiorily of the receptacle so as to be concentric therewith. In addition, the two cylinders are disposed co-axially, and because the plunger is of smaller diameter, this cylinder wall is spaced equidistance from the wall of the receptacle. The walls of both cylindrical members exhibit sufficient strength so as not to fail by the force of the damping fluid. The vertical or longitudinal dimension of the plunger 26 is selected so that its bottom perimeter or marginal edge is spaced from the bottom of the receptacle 22. Therefore, the plunger is free to move vertically upon vibration movement of the supporting member without abutting the closed bottom of the receptacle, as explained below in more detail. As a consequence, the plunger is submerged partially in the damping fluid. It will be observed that the plunger 26 extends above the surface of the viscous medium 24, and in this upper portion of the plunger wall there is provided one or more transverse openings 27 so that the openings 27 are above the surface of the viscous medium.

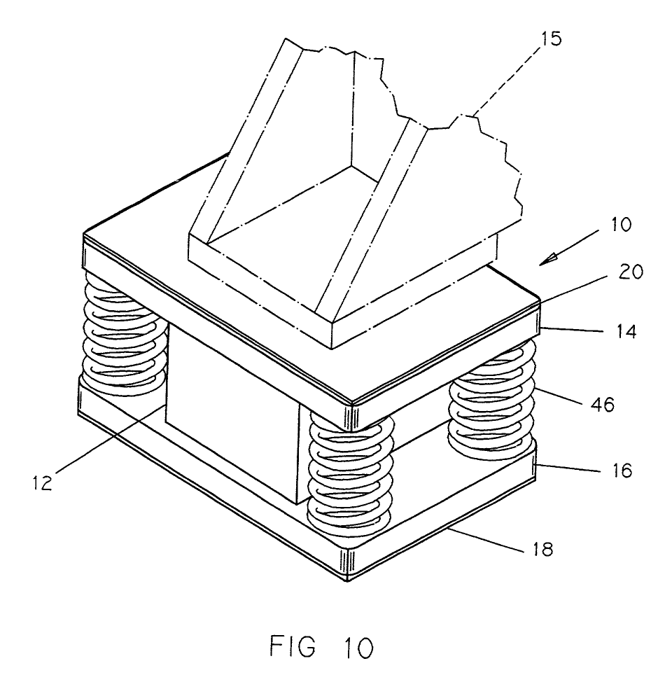

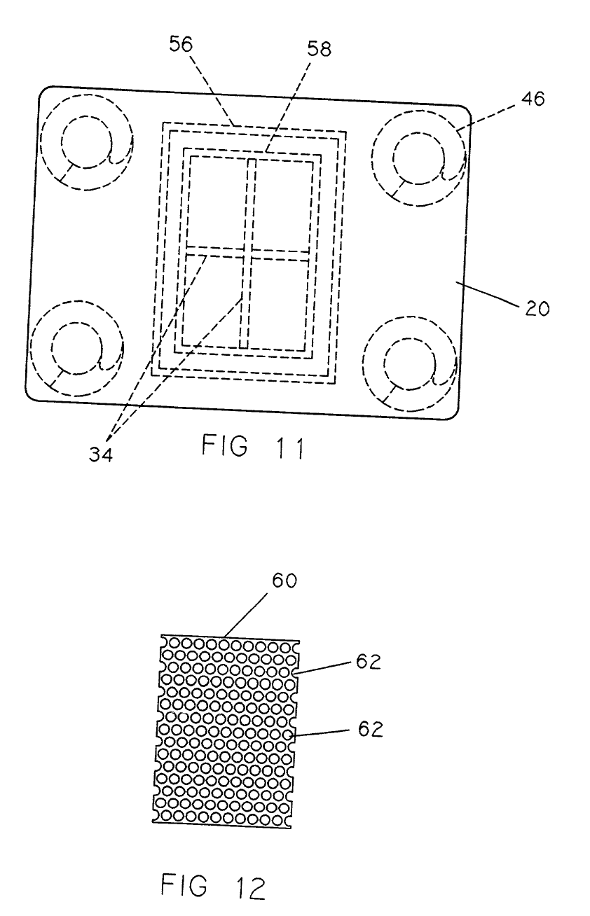

Although in the embodiment of the invention described in the FIGS. 4-7 relates to a cylindrical receptacle and cylindrical plunger, it should be understood that the invention is applicable to other configurations such as rectangular as shown in an alternative embodiment of the invention in FIGS. 10-12. Also, the opposed vertical or longitudinal walls of the receptacle and the plunger, as viewed in cross-section, are parallel, and the spacing between the walls of the receptacle and of the plunger are equal (see FIGS. 4, 5 and 11).

At about the bottom of the plunger 26 is plate member 28, disposed transversely to the longitudinal axis of the plunger, and having a plurality of openings or apertures 30. The thickness of the plate 28 is important in order to provide a plate with sufficient strength and with sufficient dampening. Where desired, one can provide two or more essentially identical plates 28A and 28B (see FIG. 7), and the plate, or the plates in the aggregate, preferably have a thickness ranging from about 0.06 inch to one inch. When multiple plates, e.g. two plates, are assembled or stacked, as shown in FIG. 7, the openings 30 are in alignment to provide for the easy flow of dampening fluid through the openings. It should be understood that the openings need not be circular, as shown, but can be of other configurations such as oval, hexagonal, or octagonal. The open area for each plate ranges from about 35 percent to 60 percent of the total area. It will be observed that the thickness of the plates, and the open area of the plates, affect the damping and the cavitation. For purposes of this invention, cavitation is defined as small voids in the fluid that coincide with a loss of damping. There is an increased damping with thicker plates, but also an increase in cavitation. The higher the closed or restricted area, relative to the open area, the stiffer the damper and the greater the dampening effect. If, however, the closed area is too high, there is increased cavitation. These parameters may be selected to optimize performance of the damper, and may vary depending upon the specific need, the size of the damper, and also other factors such as the viscosity of the fluid medium.

The distance between the cylindrical walls of the receptacle 22 and the plunger 26 can be selected or determined in order to provide for the optimum damping effect for any particular machine mounting system. As explained below in detail, the vertical displacement of the plunger will force the viscous medium to flow through the perforated plate and between the receptacle 22 and plunger 26 in one direction or the other. If the walls are too close, the shear in the damping fluid is too great which causes cavitation. If, however, the walls are too far apart, the dampening effect is diminished or lost. This optimum distance between walls can vary depending upon such factors as the relative volumes of the members 22 and 26, the size or weight of the machine, and the type and viscosity of the fluid. For many machinery mounts, a suitable radial distance between the receptacle and plunger may range from about ⅜ths inch to about 2 inches.

In order to provide sufficient strength to the machine mount or damper system, there is provided one or more fastening elements 32. As shown in FIG. 5, there are three bolt members arranged symmetrically, but this number can vary depending upon the particular application. This need for supplementing the overall strength is particularly useful in providing for a secure connection of the plunger 26 and the plate 28. Thus, the fastening elements 32, typically threaded bolts, extend from the plate member 28 to the top or supporting member 14 having complementary threaded bores for threadedly engaging the top member. It is preferred to weld the plunger 26 at its top marginal edge to the underside or bottom of the support member 14, and the fastening elements 32 reduce the weld fatigue. If any part of the weld should break, the fastening elements maintain the attachment between the plunger and the top or support member. It should be understood, however, that the fastening elements can be omitted, which is more likely for a smaller isolator system.

One or more strengthening members 34, such as a cylindrical tubes shown in FIG. 4, or as longitudinally extending plates shown in FIG. 11 and discussed below, extends between the perforated plate 28 and the top member or platform 14, and are affixed at both ends as by welding. The strengthening member is arranged interiorily to the plunger 26 in order to provide strength to the machine mounting system and support for the perforated plate 28. If the strengthening member is tube-like or cylindrical as shown in FIG. 4, it is arranged concentric with the plunger, the walls of each such strengthening member are parallel as viewed in vertical cross-section, and the space between adjacent members is equidistance. The number of such strengthening members 34, e.g. cylindrical tubes, can vary depending upon such factors as the size of the isolator, the size and dimensions of the perforated plate, and the type of viscous fluid. Thus, in FIGS. 4 and 5, there is shown one such tube 34, and the mounting system shown in FIG. 9 utilizes three such tubes arranged concentrically and symmetrically. If the support for the interior is not sufficient or is lacking, the perforated plate 28 will flex during operation of the isolator. This flexing will reduce damping, because the plate is moving with the viscous fluid instead of the fluid being forced through the holes in the plate. That portion of the strengthening members extending above the surface of the viscous fluid 24 is provided with one or more openings 36 to equalize the air pressure during operation.

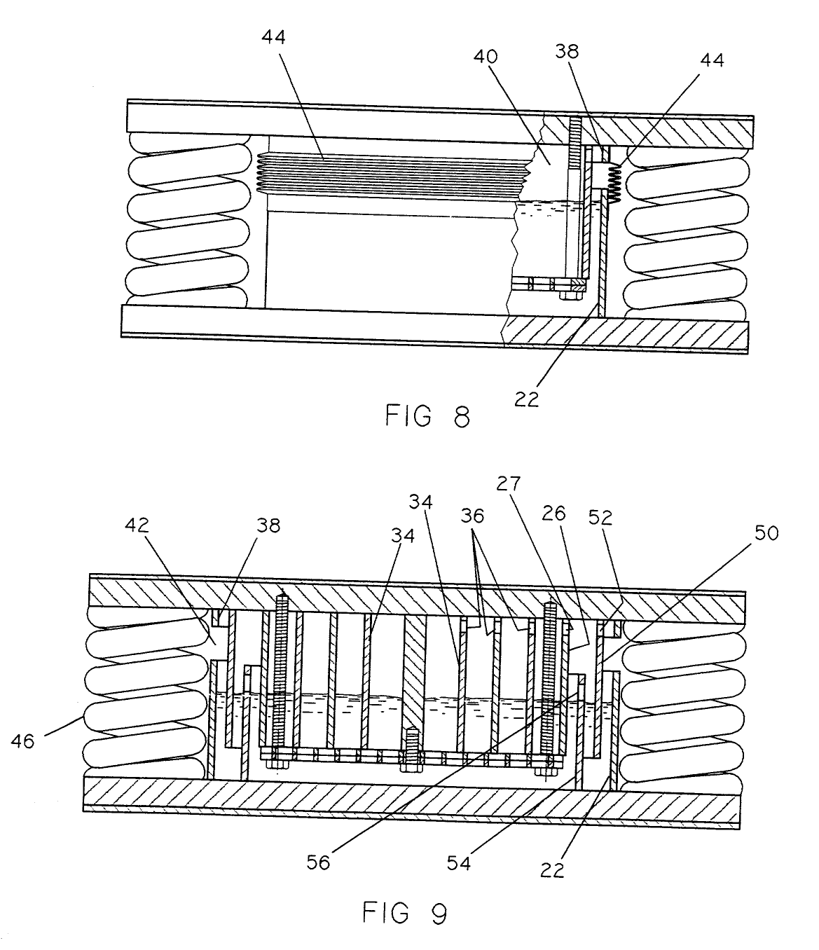

It will be observed that the receptacle 22 need be of sufficient height to contain the required quantity of viscous fluid 24. Thus, the top marginal edge or perimeter of receptacle 22 extends above the surface of the fluid 24, thereby avoiding any overflow of the fluid upon vibration amplitude or fluctuations in the level of the fluid. Annular member or rim 38 depends downwardly from top member or platform 14, and is of essentially the same lateral dimensions as receptacle 22 and co-axial therewith so as to define chamber 40 above the fluid. Thus, if the receptacle 22 is cylindrical, the rim 38 is of the same diameter; whereas if the receptacle is rectangular, then the length and width are the same for both the receptacle and the rim. The marginal edge of rim 38 is spaced from the marginal edge of the receptacle 22, thereby forming an opening or gap 42. Side seal bellows 44 surround the annular member 38 and the top of the receptacle 22 thereby encompassing the gap 42 so as to be in communication with chamber 40 through opening 27. (See FIG. 8.) The bellows are commercially available, and typically comprise a fabric coated neoprene. The bellows serve as a flexible seal to prevent contamination of the viscous fluid.

Where desired, springs 46 are arranged outside of the damper 12, and extend between the top member or platform 14 and the bottom member or bearing member 16. The springs support the load and help to regulate and maintain the relative positioning or spatial relationship of the members 14 and 16. As shown in FIG. 2, four springs are positioned symmetrically adjacent the cylindrical member 22 of the damper 12 and between the same top member 14 and bottom member 16, and optionally a protective cover (not shown) may be provided to protect the springs from dirt, oil, and the like. There is illustrated in FIG. 3 an alternative arrangement for the springs 46, which are positioned between a top member 14 and bottom member 16 and spaced from the viscous damper 12. Where desired, the springs may be spaced from the damper if the supporting member or top member 14 is fastened to the machine footing and the bottom member 16 is fastened to the floor, as with bolts 48 (see FIG. 3).

In operation, the machine mounting system including the damper and springs is first set up to support a load, such as the foot of a machine. Shock and vibrations forces emanating from the machine or through the floor will cause displacement of the dampening medium. The damper of the invention, however, reduces or substantially elates the vibration amplitude, thereby enhancing the performance and wear of the machine.

There is illustrated in FIG. 9 a modification of the embodiment shown in FIG. 4 by providing a concentric arrangement of receptacles for the damping medium. In this embodiment, there is the outermost receptacle 22 having a closed bottom and seated on bottom member 16 for containing the damping medium. Arranged concentrically with receptacle 22 and inwardly thereof is substantially cylindrical tube 50, having an air vent 52, depending downwardly from supporting member 14 and terminating above the bottom of receptacle 22. Spaced inwardly from the cylindrical tube 50, being disposed between tube 50 and the second cylindrical member 26, is a second substantially cylindrical tube 54 extending upwardly from the bottom member. Cylindrical tube 54 is provided with an opening 56 positioned near the top of the tube and at about the level of the viscous fluid. The viscous fluid can flow through the opening or holes in the inner cylindrical tube 54 and thereby maintaining an equal level of fluid in the damper 12. Also, the walls of the two tubes 50 and 54 increase substantially the surface area for contact with the viscous medium. Because the fluid tends to grip or stick to the metal surfaces of the two tubes, upon a dampening effect, the vibration amplitude of the viscous fluid and the movement of tube 50 up and down in the viscous fluid enhances the dampening effect. Also, in accordance with this embodiment, there is shown a plurality of concentrically arranged strengthening tubes 34, and each tube is provided with an opening 36. This embodiment can be an advantage for a larger damper.

In accordance with the modified embodiment illustrated in FIGS. 10, 11, and 12, receptacle 56 and plunger 58 are rectangular. Also, the bottom plate 60, with apertures 62, is rectangular and is affixed to the bottom of the plunger. The opposed walls of the plunger and the receptacle are parallel, as viewed in cross-section, and the space between the walls of these two members is the uniform throughout their perimeters, as explained above. Also, the strengthening members 34 is comprised of longitudinal ribs or plates that extend between the interior walls of the plunger 26.

It will be observed that by reason of the present invention numerous advantages are achieved with the viscous damper for decreasing vibrations from external and internal forces. Further, it should be understood that the foregoing detailed description has been given for clearness of understanding only, and no unnecessary limitations should be understood therefrom, as modifications will be obvious to those skilled in the art.

1. A vibration damper for a machinery mount having a top member, and a bottom member disposed below and spaced from the top member and adaptable to be positioned on a substructure, comprising:
(a) a receptacle closed at the bottom and open at the top for vertical disposition on the bottom member so as to have opposed parallel walls as viewed in cross-section, and having a top marginal edge spaced from the top member, thereby defining a chamber adaptable for containing a viscous medium;
(b) a plunger depending downwardly from the top member for vertical disposition partially within said receptacle and concentric therewith; said plunger having opposed parallel walls as viewed in vertical cross-section, and of the same configuration as said receptacle when viewed in plan, said walls of said plunger being uniformly spaced from said walls of said receptacle; said plunger spaced from said closed bottom of said receptacle so as to be submerged partially in the viscous medium contained in said chamber, and to be free to reciprocate vertically with reference to said receptacle; and
(c) a transversely disposed plate member affixed at about the bottom of said plunger, said plate member having a plurality of apertures to provide fluid communication between said receptacle and said plunger.

2. A vibration damper according to claim 1 further including a rim depending downwardly from the top member, said rim being spaced from the top marginal edge of said receptacle and about coinciding therewith so as to define a gap, and sealing means encompassing said gap.

3. A vibration damper according to claim 2 wherein said sealing means surrounding said gap is a bellows.

4. A vibration damper according to any one of claims 1, 2 or 3 further including one or more strengthening members disposed within said plunger and between said top member and said plate and affixed thereto, said plunger and said strengthening members having an opening at a location above the viscous medium to allow for the circulation of air.

5. A vibration damper according to claim 4 wherein said receptacle and said plunger are cylindrical, and further including a first substantially cylindrical tube downwardly depending from said top member and spaced between said receptacle and said plunger, a second substantially cylindrical tube spaced between said first cylindrical tube and said plunger and extending upwardly from said bottom member, said second cylindrical tube having an opening at about the level of said viscous medium thereby maintaining an equal level of viscous medium, said first and second cylindrical tubes of the same configuration of said receptacle and said plunger as viewed in plan.

6. A vibration damper according to claim 1 and further including a plurality of compression springs extending between the top member and the bottom member and arranged exteriorily of the receptacle.

7. A vibration damper according to claim 6 wherein said springs are arranged adjacent the receptacle.

8. A vibration damper according to claim 1 wherein said plate member has an open area ranging from about 35% to 65% of the total area of the plate.

9. A vibration damper according to claim 1 or claim 8 wherein the plate member has a thickness ranging from about 0.06 inch to one inch.

10. A vibration damper according to claim 1 wherein said plate member is comprised of two or more identical plates that are stacked and the apertures are for the plates are aligned.

11. A vibration damper according to claim 4 wherein said receptacle and said plunger are rectangular.

12. A vibration damper according to claim 4 wherein said receptacle and said plunger are cylindrical, and further including an annular rim depending downwardly from the top member, said annular rim being spaced from the top marginal edge of said receptacle and about coinciding therewith so as to define a gap

13. A vibration damper according to claim 4 wherein said receptacle and said plunger are cylindrical, and further including one or more cylindrical strengthening members disposed within said plunger and between said top member and said plate and affixed thereto, said plunger and said strengthening members having an opening at a location above the viscous medium to allow for the circulation of air.
